(19) United States
(12) Patent Application Publication
(10) Pub. No.: US 2017/0054920 A1
(43) Pub. Date: Feb. 23, 2017

(54) AIRCRAFT CAMERA VIEWING SYSTEM

(71) Applicants: Anthony de Boer, Gatineau (CA); Dylan de Boer, Gatineau (CA)

(72) Inventors: Anthony de Boer, Gatineau (CA); Dylan de Boer, Gatineau (CA)

(21) Appl. No.: 14/828,413

(22) Filed: Aug. 17, 2015

(51) Int. Cl. H04N 5/247; H04N 5/232

(52) U.S. Cl. CPC H04N 5/247; H04N 5/23293

(57) ABSTRACT

A system for enabling passengers to observe the surroundings of an aircraft has one or more weatherproof cameras mounted on an external surface of the aircraft; a network switch in communication with the one or more cameras, configured to receive and transmit the signal from the one or more cameras; a control unit in communication with the switch configured to process the camera signals into camera images; and one or more digital devices to which the camera images are transmitted from the control unit, configured to display the camera images. In an embodiment, the cameras are encased in polycarbonate. The cameras may show a cockpit view, and/or show starboard and port views, and/or show front and rear views, and/or show top and bottom views. The camera images may be transmitted by wireless signal, and the control unit may restrict the transmission of the camera images.

### FIELD OF THE INVENTION

This invention relates to systems for viewing signals from cameras mounted to the exterior of a vehicle such as an airplane.

### BACKGROUND OF THE INVENTION

Flying in planes can be a claustrophobic experience for passengers. Due to the structural requirements the windows are quite small and the field of view limited. In addition, those sitting in the middle seats on larger passenger airplanes cannot even see out the window, which may induce anxiety for some passengers. Whereas children are generally not as anxious as adults, they would still prefer an unobstructed view from the plane's cockpit and be able to see the ground while the plane is airborne. Unless a passenger has a seat adjacent to a window, he or she has a very limited view of the outside world. Moreover, the cockpit is far less accessible as a result of newly implemented secure air passenger regulations.

Aircraft security is another relevant issue as terrorists may attack the airplane from its periphery, from which those aboard cannot detect such threats. Additionally, in the event of an airplane crash, further documentation is useful to those investigating what took place. Using camera footage from the airplane's exterior, passengers may view the stars at night, and may be shown advertisement, allowing for unique marketing potential.

The in-flight view as it stands is very limited, showing passengers only an icon on a map. Additionally, the Field of View [FoV] from the cockpit is limited and only people with the window seat have access to the view albeit limited as it is. An external camera system would provide everyone with access to a broader, more pleasing view of the flight no matter where they are positioned.

Therefore, there is a need for a camera system mounted on the plane's exterior, so that passengers may view from various angles of the airplane.

### SUMMARY OF THE INVENTION

In an embodiment of the invention, a system for enabling passengers to observe the surroundings of an aircraft has one or more weatherproof cameras mounted on an external surface of the aircraft; a network switch in communication with the one or more cameras, configured to receive and transmit the signal from the one or more cameras; a control unit in communication with the switch configured to process the camera signals into camera images; and one or more digital devices to which the camera images are transmitted from the control unit, configured to display the camera images.

In an embodiment, the cameras are encased in polycarbonate. The cameras may show a cockpit view, and/or show starboard and port views, and/or show front and rear views, and/or show top and bottom views. The camera images may be transmitted by wireless signal, and the control unit may restrict the transmission of the camera images.

A system for enabling passengers to observe the surroundings of an aircraft has one or more weatherproof cameras mounted on an external surface of the aircraft; a network switch in communication with the one or more cameras, configured to receive and transmit the signal from the one or more cameras; a control unit in communication with the switch configured to process the camera signals into camera images; and an in-flight entertainment system to which the camera images are transmitted from the control unit, configured to display the camera images.

A method for enabling passengers to observe the surroundings of an aircraft, has the steps of: capturing surroundings of an aircraft with a camera to produce a camera signal; transmitting the camera signal to an encoder to encode the signal; transmitting the signal to the control unit wherein the camera signal is converted into a camera image; and transmitting the camera images from the control unit to the in-flight entertainment and one or more portable digital devices.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a schematic diagrams of presently preferred embodiments of an external viewing system for an aircraft, according to an embodiment of the invention;

FIG. 2 is a flow chart showing the data flow of the system; and

FIG. 3 is a flow chart showing the steps of a method for an external viewing system.

### DETAILED DESCRIPTION OF PREFERRED EMBODIMENTS

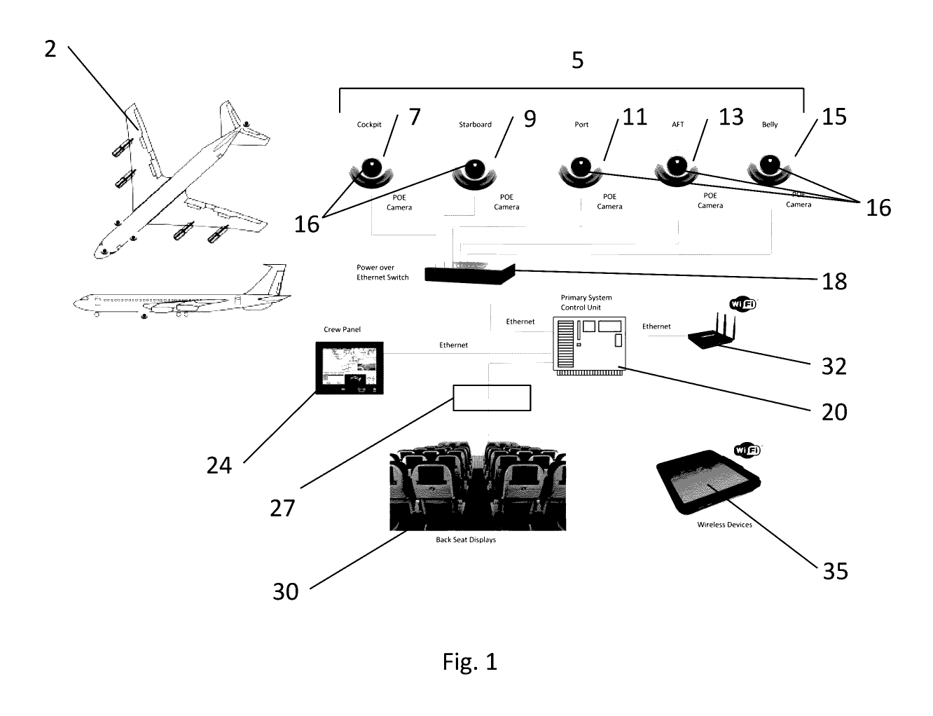

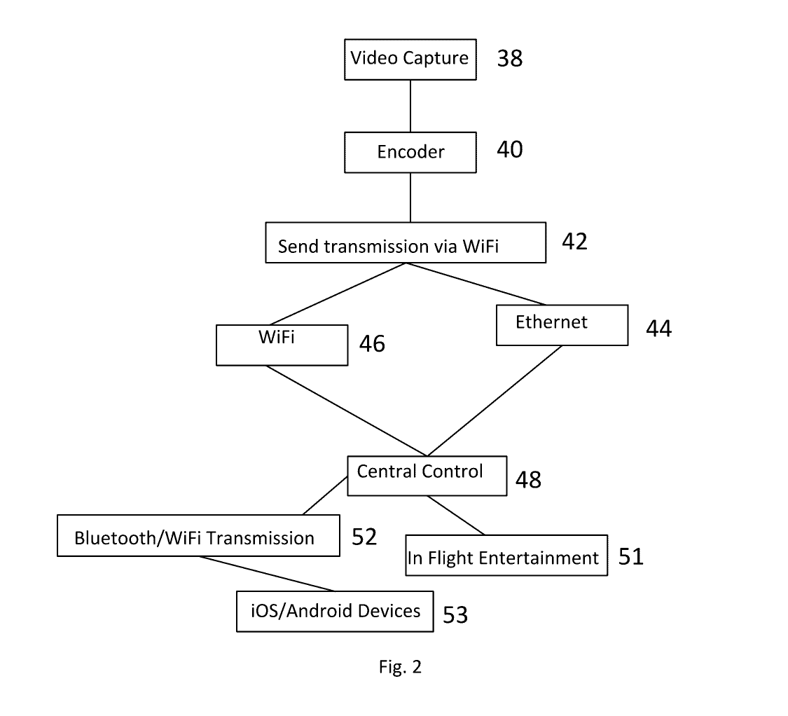

Preferred embodiments of the present invention and their advantages may be understood by referring to FIGS. 1-2 wherein like reference numerals refer to like elements.

With reference to FIG. 1, the airplane 2 has a number of external cameras 5 which permit color or black & white images from a cockpit view (camera 7), a starboard view (camera 9), a port view (camera 11), aft view (camera 13), and downward view (camera 15) from the belly of the plane. The cameras 5 are weatherproof and in an embodiment are sealed within polycarbonate enclosures 16 for protection. The cameras may have a dedicated power system, and resolution up to 1080p or greater. In addition, to reduce perforation of the aircraft fuselage, the cameras may include streaming capabilities through wireless networking, for example Wifi, Bluetooth, or Ethernet. The cameras may also have image stabilization features to avoid jerkiness. They feed into a network switch 18, such as an Ethernet switch. A wired switch is preferable to reduce conflict between wireless signals emitting from the other systems in the aircraft. However wireless signals, such as Bluetooth and Wifi are useful where there is no interference with other aircraft systems. Although basic wireless transmission may occur through hardwire Ethernet cables, Wireless transmission has the benefit of reducing perforations in the fuselage. Wi-Fi transmissions would most likely run through a 5.1 channel to remove the possibilities of direct interference with any technology whether it be personal or airline related.

The cameras 5 may be visible-light cameras, or may have infrared or ultraviolet components. The camera signals are transmitted from the network switch 18 to the primary system control unit, which converts the raw video signals into viewable image signals. In an embodiment, this conversion takes place within the camera. The crew may manage the system through the crew panel 24 which gives an overview interface of the system, including the images being transmitted by each of the cameras 5, as well as being able to control whether each of the signals is available for viewing at a given time. A master override may be available with the possibility of restricting which cameras are available to view at any given time, in the event that a camera is needed to be disabled for any reason. For example, during flight the cockpit camera may be unavailable to restrict outsider knowledge of cockpit activity.

The camera signals are also transmitted through the in-flight entertainment system (IFES) 27 to seat-back displays 30, wherein the passenger can cycle through the camera views to receive their view of choice, for example an unimpeded view downwardly from the belly of the aircraft. The camera signals may also be transmitted through a Wifi router 32 to portable wireless devices within the airplane, allowing a passenger to view the camera views one at a time, or all at once.

With reference to FIG. 2, in an embodiment, the system would have a secured network, with accessibility only through authorized channels or applications to avoid unauthorized connections. In an embodiment the system would not be connected to any part of the plane's electronics, other than the in-flight entertainment system, to avoid any unnecessary security complications that might arise. The camera signals may be tracked by the black box flight recorder. In step 38, the video is captured by cameras mounted on or near the surface of the aircraft, viewing the surroundings. In step 40, the camera signal is encoded. In step 42, the transmission is send by WiFi (step 46) or Ethernet (step 44), and in step 48 the signal is transmitted to the central control. From the central control, the signal is either transmitted through the in-flight entertainment system in step 51, or through Bluetooth/WiFi in step 52 to mobile devices in step 53.

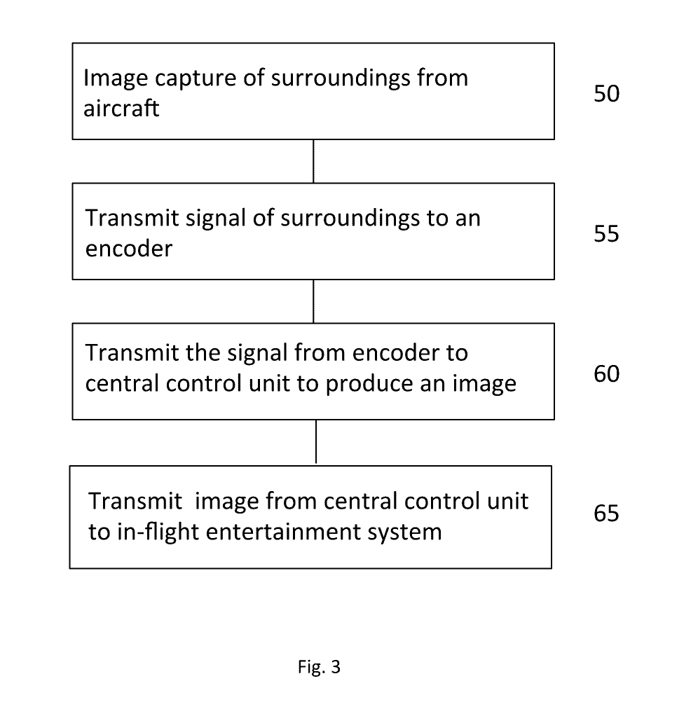

With reference to FIG. 3, the steps of a method for transmitting an outward projecting view of an airplane are as follows: in step 50, photographing an outward projecting view from the body of an airplane; in step 55, transmitting a signal of the outward projection to an encoder, in step 60, transmitting the camera signal via Wi-Fi or similar wireless communications to a central control unit, and in step 65, transmitting the signal from the central control unit to the in-flight entertainment system. Alternatively, the camera signal may be transmitted from the central control unit via wireless network to mobile devices.

The method may have the further steps of transmitting the signal to passenger wireless devices by WiFi and/or controlling the cameras that are viewed from a crew panel. The in-flight entertainment system may have the further step of displaying the views on one or more seat-back displays.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A system for enabling passengers to observe the surroundings of an aircraft, comprising:
a. one or more weatherproof cameras mounted on an external surface of the aircraft;
b. a network switch in communication with the one or more cameras, configured to receive and transmit the signal from the one or more cameras;
c. a control unit in communication with the switch configured to process the camera signals into camera images; and
d. one or more digital devices to which the camera images are transmitted from the control unit, configured to display the camera images.

2. The system of claim 1, wherein the cameras are encased in polycarbonate.

3. The system of claim 1, wherein the cameras show a cockpit view.

4. The system of claim 1, wherein the cameras show starboard and port views.

5. The system of claim 1, wherein the cameras show front and rear views.

6. The system of claim 1, wherein the cameras show top and bottom views.

7. The system of claim 1, wherein the camera images are transmitted by wireless signal.

8. The system of claim 1, wherein the control unit restricts the transmission of the camera images.

9. A system for enabling passengers to observe the surroundings of an aircraft, comprising:
a. one or more weatherproof cameras mounted on an external surface of the aircraft;
b. a network switch in communication with the one or more cameras, configured to receive and transmit the signal from the one or more cameras;
c. a control unit in communication with the switch configured to process the camera signals into camera images; and
d. an in-flight entertainment system to which the camera images are transmitted from the control unit, configured to display the camera images.

10. The system of claim 9, wherein the cameras show a cockpit view.

11. The system of claim 9, wherein the cameras show starboard and port views.

12. The system of claim 9, wherein the cameras show front and rear views.

13. The system of claim 9, wherein the cameras show top and bottom views.

14. The system of claim 9, wherein the camera images are transmitted by wireless signal.

15. The system of claim 9, wherein the control unit restricts the transmission of the camera images.

16. A method for enabling passengers to observe the surroundings of an aircraft, comprising the steps of:
a. capturing surroundings of an aircraft with a camera to produce a camera signal;
b. transmitting the camera signal to an encoder to encode the signal;
c. transmitting the signal to the control unit wherein the camera signal is converted into a camera image;
d. transmitting the camera images from the control unit to the in-flight entertainment and one or more portable digital devices.
